(19) United States
(12) Patent Application Publication
(10) Pub. No.: US 2005/0105117 A1
(43) Pub. Date: May 19, 2005

(54) Printer and printing method capable of pausing and resuming print job

(75) Inventors: Myoung-jin Oh, Suwon-si (KR); Young-ju Kim, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 10/990,384

(22) Filed: Nov. 18, 2004

(30) Foreign Application Priority Data
Nov. 18, 2003 (KR) 2003-81743

(51) Int. Cl. G06F 15/00

(52) U.S. Cl. 358/1.13; 358/1.17

(57) ABSTRACT

There is provided a printing method using a printer which includes a pause button and a resume button or a single toggling button which selects a pause and a resume of a print job. The printing method includes sensing a press of the pause button; pausing the print job of a page under printing, when the press of the pause button is sensed; and resuming the print job of the page which has been paused, when a press of the resume button is sensed, thereby pausing the print job by means of the printer alone even after printing data are output to the printer from a spooler of a computer system, reducing the printing time and papers and maintaining a document security.

### CROSS-REFERENCE TO RELATED APPLICATION

This application claims the benefit of Korean Patent Application No. 03-81743, filed on Nov. 18, 2003 in the Korean Intellectual Property Office, the disclosure of which is incorporated herein in its entirety by reference.

### BACKGROUND OF THE INVENTION

1. Field of the Invention

The present invention relates to a printer, and more particularly, to a printer and a printing method capable of controlling a print job by using the printer alone without a computer connected to the printer.

2. Description of the Related Art

Conventionally, in performing a print job through the printer connected to the computer system, a user could stop the print job by controlling operation of the printer with a mouse, etc. through a printer device program working in the computer system. That is, the operation of the printer was controlled using a printer device program of operating system programs working in the computer system, which is connected to the printer. The control method using such a printer device program is disclosed in Japanese Patent Application Publication No. 2002-283673.

A printer operates as following, when a user uses the printer. When a request for a print job is input, the operating system program in the computer system supplies the print job to a printer spooler implemented in software. The printer spooler transmits the print job after a previous print job is processed, thereby allowing the printer to perform the print job.

After the print job is transmitted to the printer from the printer spooler, the print job departs from the control of the operating system program or the printer spooler, so that the corresponding print job should be cancelled in the printer or be performed completely, even if a user wants to stop the corresponding print job. Further, when the user wants to exchange new ink cartridge due to deterioration of print quality in the course of performing the printing job, the print job should be performed again after the whole print job is cancelled or finished with the deteriorated print quality.

Additionally, when the user should leave the computer due to any urgent work in the course of performing the print job, the print job of a private document or an important document requiring security should be cancelled as a whole and be performed again later, so as to prevent the printed document from being leaked when the user leaves the seat.

Therefore, this procedure may give fairly inconvenience to the user. For example, when the amount of the print job is large, a great deal of time is required for performing the print job again, so that a large amount of ink and papers may be wasted. In addition, in a case where the print job is stopped through a program control, it takes time for the user to obtain a result of stopping the print job, after the user decides to stop the print job.

The aforementioned inconveniences may become more serious, specifically when the print job is stopped and restarted in the course of carrying out the print job in an environment in which several computers share one printer through a network.

### SUMMARY OF THE INVENTION

Additional aspects and/or advantages of the invention will be set forth in part in the description which follows and, in part, will be obvious from the description, or may be learned by practice of the invention.

An aspect of the present invention provides a printing method capable of pausing a print job under printing and resuming the print job from the paused state with a printer alone, with minimizing a participation of an operating system program of a computer connected to the printer or without the participation of the operating system program, and a printer implementing the printing method.

According to an aspect of the present invention, there is provided a printing method capable of pausing and resuming a print job by using a printer which comprises a pause button and a resume button or a single toggle button which selects a pause and a resume of a print job, the method comprising: sensing a press of the pause button; pausing the print job of a page under printing, when the press of the pause button is sensed; and resuming the print job of the page which has been paused, when a press of the resume button is sensed.

According to another aspect of the present invention, there is provided a printer capable of pausing and resuming a print job, the printer being connected to a computer system and performing the print job in response to a printing request from the computer system, the printer comprising: a stop button that is pressed by a user to pause the print job; a resume button that is pressed by the user to resume the print job that has been paused; and a control unit that pauses the print job of a page under printing when a press of the pause button is sensed, and resumes the print job that has been paused when a press of the resume button is sensed during pausing the print job.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram illustrating a printer connected to a computer system according to an aspect of the invention;

FIG. 2 is a flowchart illustrating a printing method according to an aspect of the present invention;

FIG. 3 is a block diagram illustrating a structural example of a printer according to an aspect of the present invention;

FIG. 4 is a flowchart illustrating a method of processing a new printing request when the printer is in a paused state according to the present invention;

FIG. 5 is a diagram illustrating an example of contents to be displayed a display unit when another printing request is input in a pause mode; and

FIG. 6 is a diagram illustrating an example of contents to be displayed in a monitor of a computer system connected to the printer when another printing request is input in a pause mode.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

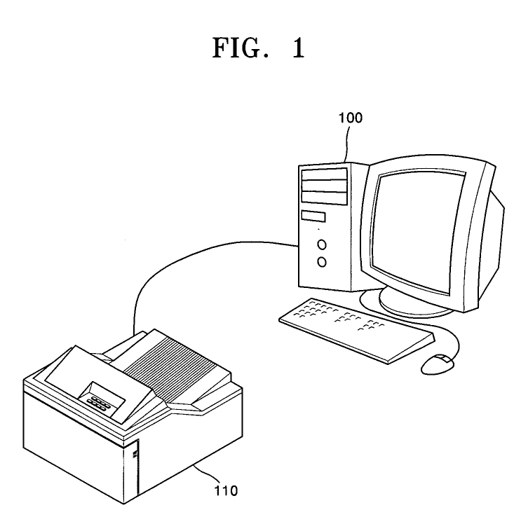

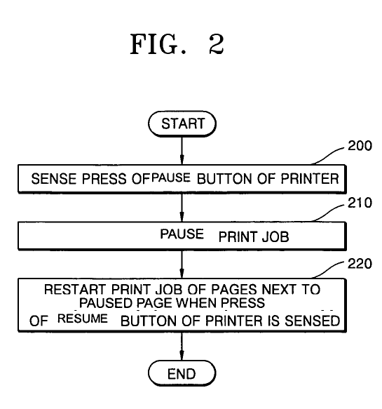

FIG. 1 is a diagram illustrating a printer 110 connected to a computer system 100 according to an aspect of the invention. In performing a print job through the printer 110 connected to the computer system 100, a user could stop the print job according to an aspect of the invention as set forth below in conjunction with FIGS. 2 through 6. While not required in all aspects of the invention, it is understood that the print job can be further controlled by operation of the printer 110 with a mouse, etc. through a printer device program working in the computer system 100. Moreover, while shown in the context of a computer system 100, it is understood that the computer system 100 can be, in addition to or instead of a general or special purpose computer, a personal digital assistant, a digital camera, or other such device which is capable of outputting information and/or images to be printed.

FIG. 2 is a flowchart illustrating a printing method according to the present invention. While not required, the method is performed using a pause button and a resume button or a single toggle button which selects a pause mode and a resume of the print job of the printer 110. The method comprises sensing a press of the pause button (operation 200), pausing the print job of a page being printed when the press of the pause button is sensed (operation 210), and resuming the print job having been paused at operation 210 when the press of the resume button is sensed after operation 210 (operation 220).

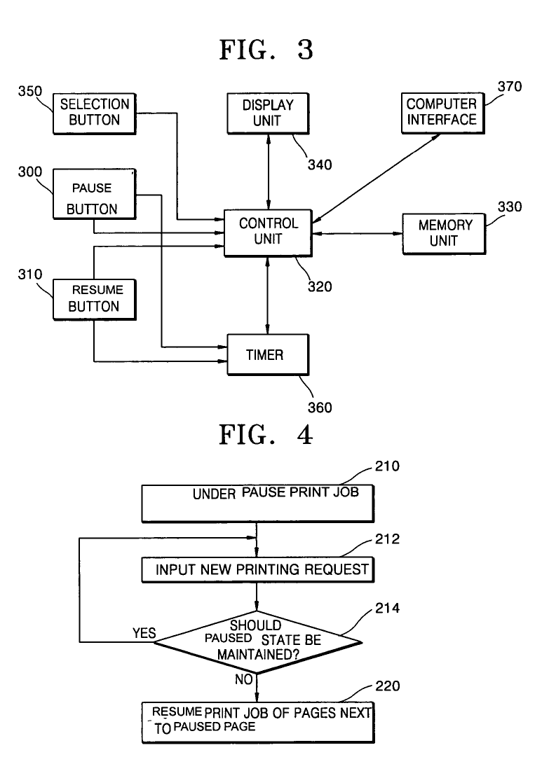

FIG. 3 is a block diagram illustrating a structural example of a printer 110 according to an aspect of the present invention. The printer 110, which is connected to a computer system 100 and performs a print job in response to a print job request from the computer system 100, comprises a pause button 300 that is pressed to pause the print job by a user, a resume button 310 that is pressed to resume the print job by the user in a state where the print job is paused, and a control unit 320 that senses a press of the pause button 300 to pause the print job and senses a press of the resume button 310 when the print job is paused, to resume the paused print job.

The printer 110 further comprises a memory unit 330 that temporarily stores data, a display unit 340 that displays an inquiry about whether the paused state should be maintained or not, a selection button 350 to which a response to the inquiry displayed on the display unit 340 is input, and a timer 360 that outputs a time-out signal if a predetermined time passes after the print job is paused by the control unit 320 through the press of the pause button 300.

In addition, the printer 110 further comprises a computer interface 370 that receives data to print, transmits conditions of the printer 110, and is connected to a computer system 100 or a network connected to processing devices.

In FIG. 3, the pause button 300 and the resume button 310 are shown separately. However, it is understood that the two buttons 300 and 310 may be implemented as a single button so as to reduce an area in which the buttons are provided. For this purpose, it is preferable, but not required, that the pause button 300 and the resume button 310 is implemented as a single toggle button having a toggle function, so that the single toggle button functions as the pause button 300 if the single toggle button is pressed during normal printing, and functions as the resume button 310 if the single toggle button is pressed in the pause mode. However, it is understood that other input devices can be used to control the printer 110 according to aspects of the invention, such as touch screen displays and/or remote control devices which transmit pause and resume commands.

Using the method shown in FIG. 2 and the printer 110 shown in FIG. 3, an operation of an aspect of the present invention will be described in detail. Print information and signals requesting a print job from the computer system 100 connected through the computer interface 370 are transmitted to the printer 110. Control information and data to be printed are included in the print information. Further, a parallel port or a universal serial bus (USB) port to be connected to the computer system 100 is included in the computer interface 370. Furthermore, through the computer interface 370, information such as print conditions can be transferred to the computer system from the printer according to an aspect of the present invention. While described in terms of a wire-based connection, it is understood that the interface 370 can receive signals across a wireless connection.

The printer 110 shown in FIG. 3 according to an aspect of the present invention comprises a specific structure for printing in addition to the aforementioned structure. However, the specific structure for printing is similar to that of a conventional printer. Therefore, since the specific structure for printing is apparent to the ordinary skilled in the art, it is not shown in FIG. 3, and descriptions thereof will be also omitted.

By way of example, in a computer system 100 employing Windows program as an operating system program, a desired printout is obtained by controlling the printer 110 through a printer driver program working in the Windows program, when data is transmitted to the printer for printing. In this case, the printer driver program inputs data to be printed to a printer spooler supplied by the Windows operating program. In a case where various data files to be printed exist in the spooler, they may be usually transmitted to the printer in a first-in first-out (FIFO) method and printed in that order. However, it is understood that other operating systems, such as LINUX or an operating system produced by Apple Computer could be used.

When a print job of one file should be paused in the course of printing the files in the printer spooler can be controlled by the printer driver program of the computer system 100, but the computer system cannot control the file being printed, which is already transmitted to the printer 110. Therefore, in this case, conventionally, the print job of the printer 110 is cancelled by turning off the printer 110, and then the printer 110 is turned on again to resume the print job. At this time, in accordance with kinds of the printer 110, the file being printed when the printer 110 is turned off may be printed again, or may be transmitted again to the printer from the computer system and then printed. Conventionally, even in any case, when a print job is resumed after canceling operation of the printer, a part of the file having been cancelled should be printed again.

According to an aspect of the present invention, when the operation of the printer should be paused, a user presses the pause button 300, and a control unit 320 senses the press (step 200) and pauses the print job of the page under printing (step 210).

At this time, the print job may be paused after the print job of the page under printing is completed. For this purpose, when the press of the pause button 300 is sensed (step 200), the control unit 320 completes the print job of the page being printed at that time, discharges the printed sheets through a sheet discharge port, and then pauses the printing operation of the printer. However, it is understood that such an operation is not required in all aspects of the invention and that it is possible for page being completely printed need not be completely printed in all aspects of the invention.

Of course, in this case, if the press of the resume button is sensed after step 210, at step 220, pages next to the page having been printed and discharged at step 210 are printed. However, it is understood that such an operation is not required in all aspects of the invention and that it is possible for a page whose printing was paused to be reprinted.

It is preferable that the control unit 320 senses the press of the pause button 300 by means of an interrupt signal generated when the pause button 300 is pressed. The press of the pause button 300 generates the interrupt signal, and the control unit 320 sensing the interrupt signal can execute an interrupt service routine that provides the method according to an aspect of the present invention on the basis of an interrupt number included in the interrupt signal. Alternatively, in a case where the interrupt number is not included, the interrupt service routine may be executed in accordance with a source generating the interrupt signal.

When the press of the pause button 300 is sensed, the control unit 320 allows a portion or page under printing at that time to be printed out and allows the operation of the printer 110 to be paused. For this purpose, the control unit 320 may include a function of controlling the whole printing operation of the printer 110, or may allow another control means (not shown) controlling the printing operation of the printer 110 to pause the printing operation of the printer 110.

For the case of resuming the print job, the memory unit 330 temporarily stores data not printed yet after the control unit 320 senses the press of the pause button 300. Further, when the press of the resume button 310 is sensed, the control unit 320 reads out and prints the data stored in the memory unit 330.

Furthermore, it is preferably notified to the computer system 100 that the printer 110 is in the paused state. For this purpose, when the print job is paused through the press of the pause button 300, the control unit 320 may notify the pause of the print job to the computer system 100, which is connected to the printer 110 and transmits the print job request to the printer 110. In this case, terminal means such as a monitor of the computer system 100 can display information that the printer 110 cannot be used or that the print job is paused. When data to be printed remains in the printer spooler, the computer system may not output the data to the printer 110.

Where the printer 110 according to an aspect of the present invention is in the pause mode, the printer 110 displays the inquiry about whether the pause mode of the printer 110 should be maintained and receives a response to the inquiry, for example, for the purpose of notifying the user of the pause mode, or when the computer system 100 not recognizing the pause mode of the printer 110 transmits a printing request to the printer 110 through a network.

FIG. 4 is a flowchart illustrating a method of processing a new printing request when the printer 110 is in the pause mode according to an aspect of the present invention. If the new printing request is input to the printer 110 in a case where the printer is in the pause mode at step 210 (step 212), it is displayed whether the pause mode of the printer 110 should be maintained, and the user's selection is received (step 214). At this time, in accordance with the user's selection, the pause mode may be maintained, or the pause mode may be released to resume the print job at step 220.

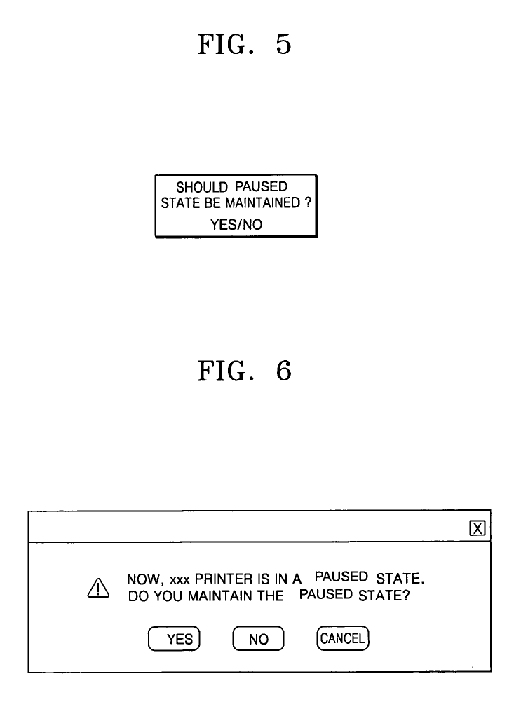

FIG. 5 is a diagram illustrating an example of contents to be displayed on the display unit 340 when another printing request is input to the printer in the pause mode. The user's response to the inquiry displayed on the display unit 340 is input through the selection button 350. The control unit 320 can maintain the pause mode or release the pause mode to resume the print job in accordance with the input by the user.

The pause button 300, the resume button 310, and the selection button 350 are provided on the printer 110, so that a user can be allowed to easily press the buttons. The display unit 340 is also provided on the printer 110 by using an element such as LCD or LED. However, it is understood that the display unit 340 need not be integral to the printer 110 and can be provided on another element connected to the printer 110.

The pause mode and the resume mode of the printer 110 according to an aspect of the present invention can be executed independently from the computer system 100 connected to the printer 110. However, for the purpose of the user's convenience, by displaying the message shown in FIG. 6 on a monitor of the computer system 100, the pause mode of the printer 110 may be maintained or released according to the user's selection. For this purpose, a control signal representing that the pause mode should be maintained or released is generated by a printer drive program of the computer system 100 on the basis of the user's selection, and transferred to the control unit 320 through the computer interface 370 according to an aspect of the invention.

In the case where the printing operation of the printer 110 is paused as described above, it may be required that more urgent documents than the document of which the print job is being performed or is paused should be printed. When a print job of the more urgent documents is requested to the printer 110 in the pause mode through the computer system 100 connected to the printer 110, the printer 110 according to the present invention can allow the user to give priority to one of the paused print job and the new printing request.

For this purpose, when another printing request is input to the printer 110 in the pause mode, the display unit 340 may display the another printing request, and the selection button 350 may further comprise a selection mechanism (such as a button) through which the user can select the another printing request displayed on the display unit 340. Accordingly, the control unit 320 can first perform a print job in response to another printing request in accordance with input states of the selection button 350 by the user.

For example, when another printing request is transferred to the printer in the pause mode, the display unit 340 displays another printing request and an inquiry about whether the print job in response to the another printing request should be first performed or not. Then, when the user presses a predetermined key provided in the selection button 350 to select, for example, Yes or No, the control unit 340 may first perform the print job in response to the another printing request in accordance with the selection of the user.

In this case, all data representing that the print job is paused during printing and that another printing request is transmitted from the computer in the pause mode of the printer 110 are stored in the memory unit 330 of the printer 110. The printer 100 according to an aspect of the present invention provides the function that a user can give priority to one of the print jobs, so that the paused print job may be successively performed or the print job corresponding to another printing request may be first performed.

In a case where the file of which the print job is paused is a file requiring security, there may be a problem that a person other than an authorized person can press the resume button 310 and watch the printed sheets. In order to prevent such a problem, the pause mode may be cancelled after the printer is in paused mode in a predetermined time.

For this purpose, an aspect of the invention includes a timer 360 to output a time-out signal in a predetermined time after the stop button 300 is pressed and the print job is paused. The control unit 320 cancels the paused print job, if the resume button 310 is not pressed until the time-out signal is output from the timer 360. That is, the pause mode of the printer 110 turns to a completely stopped state. However, it is understood that the timer 360 need not be used in all aspects of the invention.

The predetermined time may be changed by the user.

The control unit 320 may be programmed to implement the present invention by using an element such as a programmable logic design (PLD), a field programmable gate array (FPGA), or an application specific integrated circuit (ASIC), or may comprise a commercial processor and a storage medium such as a read only memory (ROM) or a flash memory in which programs allowing the processor to implement the present invention are stored.

In another embodiment of the present invention, when the resume button is pressed after the printing operation of the printer 110 is paused, the display unit 340 may display an inquiry for password on the display unit 340 so as to confirm whether a rightful person has pressed the resume button, and the printer 100 may resume the paused print job of operation 220 only if a predetermined password, which may be changed by the authorized person, is input.

An aspect of the present invention provides the printer with a function of pausing the print job. Therefore, the print job can be paused independently of the computer system, even after data to be printed are output to the printer through the printer spooler of the operating system program. An aspect of the present invention provides a stand-alone function which is independent of the computer system. That is, an aspect of the present invention provides the printer itself with the function of pausing the printing operation and resume the printing operation.

By using the function of pausing and resuming a print job according to an aspect of the present invention, in a case where the ink cartridge of the printer should be exchanged and thus the print quality is deteriorated in the course of performing the print job output from the spooler of the operating system program of the computer system, the ink cartridge can be exchanged after pausing the printer by using the pause function according to an aspect of the present invention. Then, by pressing the resume button provided in the printer, the print job of the paused document can be resumed from a page next to the paused page.

In addition, it will be understood by those skilled in the art that the respective operations and sub-operations of aspects of the present invention can be implemented variously in software or hardware by using general programming methods.

Some operations of the present invention can also be embodied as computer readable code on at least one computer readable recording medium. The computer readable recording medium is any data storage device that can store data which can be thereafter read by one or more computer systems. Examples of the computer readable recording medium include, but are not limited to, read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

According to an aspect of the present invention, there is provided a printing method capable of pausing and resuming a print job by using a printer which comprises a pause button and a resume button or a single toggle button which selects a pause and a resume of the print job, the method comprising: sensing a press of the pause button; pausing the print job of a page under printing, when the press of the pause button is sensed; resuming the print job of the page which has been pause, when a press of the resume button is sensed; and providing a pause function of the page to the printer itself, thereby giving a print pause function to the printer itself. As a result, the printer can independently pause a print job, even after printing data are output to the printer from a spooler of the computer system.

Furthermore, according to the present invention, when ink cartridge of a printer are deteriorated, the print job can be paused, and resumed after exchange of the ink cartridge. Therefore, printing time and papers, which were otherwise wasted in conventional systems, can be saved, so that it is possible to enhance a user's convenience.

Conventionally, a beginner should perform many processes so as to pause the print job in operating system programs of a computer system, and he could not obtain satisfactory results, even if performing such works. Specifically, a print job departing from control of the printer spooler could not be stopped by means of the operating system programs. However, in the present invention, by providing a pause and resume function to a printer, a beginner can pause and resume the print job through a simple press of buttons.

In addition, conventionally, in a case where the user should leave the seat during printing, private documents or important documents requiring security could be leaked. However, according to an aspect of the present invention, a user can prevent other persons from seeing the private documents or the important documents requiring security by using the pause function.

Therefore, by using the printing method and the printer according to aspects of the present invention, a user's convenience can be enhanced, so that it is possible to improve an environment in which the computer and the printer are used.

Although a few embodiments of the present invention have been shown and described, it would be appreciated by those skilled in the art that changes may be made in these embodiments without departing from the principles and spirit of the invention, the scope of which is defined in the claims and their equivalents.

1. A printing method capable of pausing and resuming a print job by using a printer which comprises a pause button and a resume button or a single toggle button which selects a temporary stop and a resume of the print job, the method comprising:
sensing a press of the pause button;
pausing the print job of a page being printed, when the press of the pause button is sensed; and
resuming the print job of the page which has been paused, when a press of the resume button is sensed.

2. The printing method according to claim 1, wherein:
the pausing the print job comprises, when the press of the pause button is sensed, completing the print job of the page being printed and pausing the printing for remaining pages of the print job which have not been printed, and
the resuming the print job comprises, when the press of the resume button is sensed, resuming the print job for the remaining pages.

3. The printing method according to claim 1, wherein:
the pausing the print job comprises, when the press of the pause button is sensed, temporarily storing data of remaining pages in the print job which are not being printed, and
the resuming the print job comprises, when the press of the resume button is sensed, the printing the remaining pages using the temporarily stored data.

4. The printing method according to claim 2, wherein:
the pausing the print job comprises, when the press of the pause button is sensed, temporarily storing data of remaining pages of the print job which have not been printed, and the resuming the print job comprises, when the press of the resume button is sensed, printing the remaining pages using the temporarily stored data.

5. The printing method according to claim 1, wherein, where another printing request is input to the printer when the print job is paused, it is requested through a display whether the pause mode should be maintained, and the pause mode is maintained or released to perform the resuming the printing in accordance with a response to the request.

6. The printing method according to claim 1, wherein, where another printing request is input to the printer for another print job when the print job is paused, a request for input is displayed, and the print job corresponding to the another printing request is performed before the resuming the paused print job in accordance with a response to the request.

7. The printing method according to claim 2, wherein, where another printing request for another print job is input to the printer when the print job is paused, a request for input is displayed, and the print job corresponding to the another printing request is performed before the resuming the paused print job in accordance with a response to the request.

8. The printing method according to claim 1, further comprising, when the resume button is not pressed within a predetermined time after the print job is paused, cancelling the paused print job.

9. The printing method according to claim 2, further comprising, when the resume button is not pressed within a predetermined time after the print job is paused, cancelling the paused print job.

10. The printing method according to claim 8, further comprising a user changing the predetermined time.

11. A printer capable of paused and resuming a print job, which is connected to at least one computer system, comprising:
a print unit that performs the print job in response to a printing request from the computer system;
a pause button that is pressed by a user to pause the print job;
a resume button that is pressed by the user to resume the paused print job; and
a control unit that controls the print unit and pauses the print job of a page being printed when a press of the pause button is sensed, and resumes the paused print job when a press of the resume button is sensed while the paused print job remains paused.

12. The printer according to claim 11, further comprising a single toggle button comprising the pause button and the resume button, wherein the single toggle button functions as the resume button when the single toggle button is pressed during normal printing operation, and functions as the resume button when the single toggle button is pressed in the pause mode.

13. The printer according to claim 11, wherein, when the press of the pause button is sensed, the control unit controls the print unit to complete the print job of a page being printed and then to pause printing of at least one remaining page of the print job which has not been printed, and when a press of the resume button is sensed, the control unit controls the print unit to resume the paused print job for the at least one remaining page.

14. The printer according to claim 11, further comprising a memory unit that temporarily stores data of at least one remaining page of the paused print job which have not been printed when the press of the pause button is sensed by the control unit,
wherein, when the press of the resume button is sensed by the control unit, the control unit reads the stored data of the remaining pages from the memory unit and controls the print unit to print the at least one remaining page using the read data.

15. The printer according to claim 13, further comprising a memory unit that temporarily stores data of at least one remaining page of the paused print job which has not been printed when the press of the pause button is sensed by the control unit,
wherein, when the press of the resume button is sensed by the control unit, the control unit reads the stored data of the at least one remaining page from the memory unit and controls the print unit to print the at least one remaining page using the read data.

16. The printer according to claim 11, further comprising:
a display unit that displays an inquiry generated by the control unit about whether the paused state should be maintained, where another printing request is input to the printer from the computer system while the paused print job remains paused; and
a selection button through which is input to the control unit a response to the displayed inquiry,
wherein the control unit maintains or releases the paused state to resume the paused print job in accordance with input states of the response received using the selection button after the displayed inquiry.

17. The printer according to claim 13, further comprising:
a display unit that displays an inquiry generated by the control unit about whether the paused state should be maintained, in a case where another printing request is input to the printer from the computer when the print job is paused; and
a selection button through which a response to the inquiry displayed in the display unit is input by the user,
wherein the control unit maintains or releases the stopped state to restart the print job in accordance with input states of the selection button by the user after the inquiry about the paused state should be maintained or not is displayed on the display unit.

18. The printer according to claim 16, wherein:
the display unit displays another printing request, where the another printing request is input to the printer while the paused print job is paused,
the selection button further comprises input states selectable between allowing the displayed another printing request to be selected and not allowing the another printing to be selected, and
the control unit performs another print job corresponding to the another printing request before resuming the paused print job in accordance with the input states of the selection button after the another printing request is displayed on the display unit.

19. The printer according to claim 11, further comprising a timer that outputs a time-out signal when a predetermined time passes after the pause button is pressed and the paused print job remains paused,
wherein the control unit cancels the paused print job when the resume button is not pressed to resume the paused print job and the time-out signal is output from the timer.

20. The printer according to claim 13, further comprising a timer that outputs a time-out signal when a predetermined time passes after the pause button is pressed and the paused print job remains paused,
wherein the control unit cancels the paused print job when the resume button is not pressed to resume the paused print job and the time-out signal is output from the timer.

21. The printer according to claim 11, wherein the control unit notifies the computer system, which transmitted the printing request to the printer, that the paused print job is paused, where the pause button is pressed and the paused print job is paused by the printer.

22. The printer according to claim 13, wherein the control unit notifies the computer system, which transmitted the printing request to the printer, that the print job is paused, in a case where the pause button is pressed and the print job is thus paused.

23. The printer according to claim 11, wherein:
the control unit senses the press of the pause button through an interrupt signal generated when the pause button is pressed, and
the control unit senses the press of the resume button through an interrupt signal generated when the resume button is pressed.

24. The printer according to claim 13, wherein:
the control unit senses the press of the pause button through an interrupt signal generated when the pause button is pressed, and
the control unit senses the press of the resume button through an interrupt signal generated when the resume button is pressed.

25. The printing method according to claim 3, wherein, where another printing request is input to the printer for another print job when the print job is paused, a request for input is displayed, and the print job corresponding to the another printing request is performed before the resuming the paused print job in accordance with a response to the request.

26. The printing method according to claim 4, wherein, where another printing request for another print job is input to the printer when the print job is paused, a request for input is displayed, and the print job corresponding to the another printing request is performed before the resuming the paused print job in accordance with a response to the request.

27. A printing method of pausing and resuming for a print, the method comprising:
pausing a printing job using a signal received at the printer;
inquiring for a password;
checking whether the password is input; and
continuing to pause the printing job if the password is not inputted until predetermined a time period.

28. The printing method of claim 27, further comprising resuming the printing job if the password is input and is correct.

29. A computer readable medium encoded with processing instructions for implementing the method of claim 1 implemented by at least one computer.

30. The printer according to claim 11, wherein the computer system comprises a printer spooler, and the paused print job comprises a print job which has been spooled by the printer spooler and transmitted to the printer before being paused.
